(19) United States
(12) Patent Application Publication
(10) Pub. No.: US 2006/0197865 A1
(43) Pub. Date: Sep. 7, 2006

(54) Focus device for cameras

(76) Inventors: Henryk Birecki, Palo Alto, CA (US); Robert Walmsley, Palo Alto, CA (US); Manish Sharma, Palo Alto, CA (US); Stevel Louis Naberhuis, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/073,986

(22) Filed: Mar. 7, 2005

(51) Int. Cl. H04N 5/232

(52) U.S. Cl. 348/345

(57) ABSTRACT

Provided is a focus device for a camera. The focus device moves an image sensor toward, or away from, the incoming light of an image according to commands received from a processor/controller. The focus device includes an actuator for inducing movement of the image sensor, and a position sensor for measuring the distance moved. In one embodiment, the actuator is a voice coil actuator comprising a plurality of magnets and a coil winding. In an alternate embodiment, the actuator is a piezo-bimorph actuator of a type well known in the art. Operation of the actuator is controlled by the processor/controller. Further, the resulting measurement data from the position sensor is used by one or more focusing algorithms in the camera to focus the image.

### FIELD OF THE INVENTION

This invention relates generally to focus devices for cameras. More particularly, to a focus device wherein an imaging sensor in a camera is moved using an actuator to bring an image into focus.

### BACKGROUND

Current digital camera designs most often achieve image focus by moving a camera lens or camera lens elements. Typically, a stepping motor controlled by a microprocessor is used to move the camera lens. In a relative sense, the camera lens is a large, heavy component of the camera, therefore, the stepping motor is quite often large as well. Further, a substantial amount of system power, usually supplied by one or more batteries, may be required to operate the stepping motor.

Many cameras use an iterative focusing algorithm, whereby the lens may be moved several times prior to an image coming into focus. Specifically, the sequence of events begins with the lens moving in accordance with commands received from a controller. The focusing algorithm then performs image analysis to assess image focus. If required, the lens is moved once again, and further image analysis is performed. This iterative process continues until the image analysis satisfies predetermined focus criteria.

A second focusing technique includes moving the lens to a pre-defined position calculated to bring the image into focus. The position of the lens is often determined by either a position sensor, a “time of flight” or movement calculation, or through triangulation. Although this technique is not typically iterative, it still requires movement of the lens.

Regardless of the focusing technique and algorithm used by a particular camera, the speed with which the camera lens can be moved is limited by a number of variables, including: lens mass; stepping motor power; and, general optical-mechanical restrictions inherent in the movement of a lens. As the design and sophistication of cameras (digital, video, etc.) continues to improve, focusing speed becomes a significant limiting factor, if not the primary limiting factor, for camera speed of operation. Further, in a camera that achieves focus by moving the lens, the lens in such cameras is typically a complicated design of moving parts.

Hence, there is a need for a system and method for focusing a camera that overcomes one or more of the drawbacks identified above.

### SUMMARY

The present disclosure advances the art and overcomes problems articulated above by providing a device and method for focusing a camera.

In particular, and by way of example only, according to an embodiment, provided is a focus device for a camera including: an image sensor; a movable housing for containing the image sensor, the housing defining a plane; an actuator mechanism for inducing a force substantially along an axis oriented perpendicular to the plane, to move the housing and image sensor axially and out of the plane; a position sensor for generating an output signal proportional to an axial distance moved by the housing and image sensor; and a controller for controlling the actuator mechanism, and for receiving the output signal from the position sensor, wherein the output signal is used by the controller as input to at least one focusing algorithm in the camera.

### BRIEF DESCRIPTION OF THE DRAWINGS

FIG. 1 is a perspective view of a focus device for a camera, according to an embodiment;

FIG. 2 is a plan view of a focus device for a camera having a voice coil actuator, according to an embodiment;

FIG. 3 is a partially cut-away side view of a focus device for a camera having a voice coil actuator, according to an embodiment;

FIG. 4 is a partially cut-away side view of a focus device for a camera having a piezo-bimorph actuator, according to an embodiment;

FIG. 5 is a partially cut-away side view of a focus device for a camera showing movement of an imaging sensor in a forward direction, according to an embodiment; and

FIG. 6 is a partially cut-away side view of a focus device for a camera showing movement of the imaging sensor in a rearward direction, according to an embodiment.

### DETAILED DESCRIPTION

Before proceeding with the detailed description, it is to be appreciated that the present teaching is by way of example, not by limitation. The concepts herein are not limited to use or application with one specific type of focus device for a camera. Thus, although the instrumentalities described herein are for the convenience of explanation, shown and described with respect to exemplary embodiments, it will be appreciated that the principles herein may be equally applied in other types of focus devices for any of a number of different types of cameras.

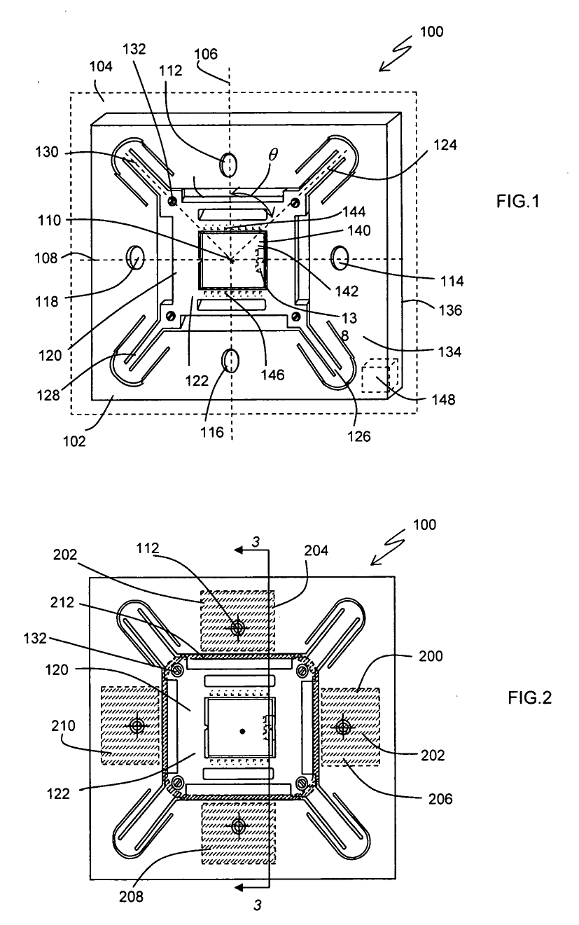

FIG. 1 shows a focus device 100 for a camera. The focus device 100 includes a frame 102 which defines a plane 104. In one embodiment, frame 102 is substantially rectangular in shape, and may be square. Further, in at least one embodiment, frame 102 defines a centerline 106 and a centerline 108. As shown, centerlines 106 and 108 pass through a center point 110 of focus device 100. Further, centerlines 106, 108 lie in plane 104, and are oriented substantially perpendicular to one another.

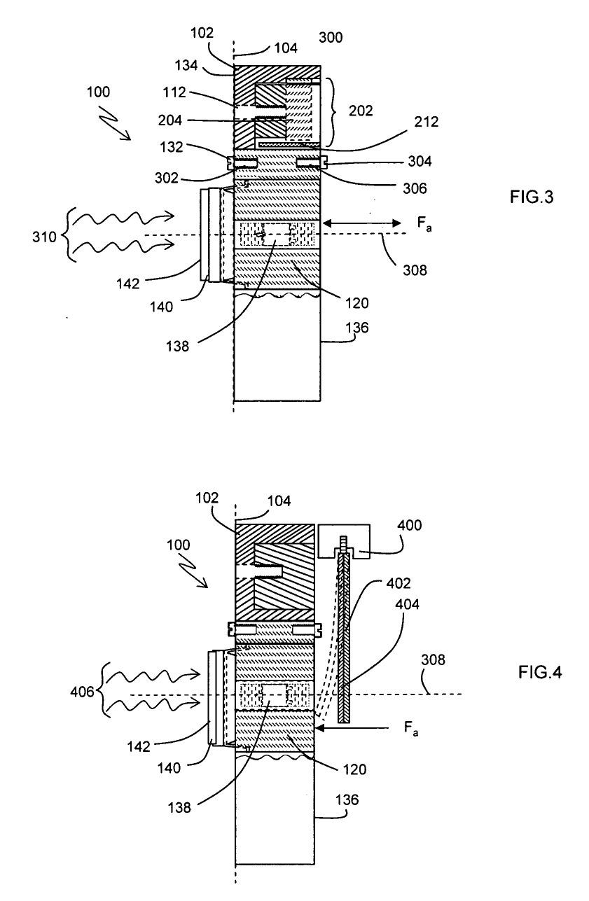

Frame 102 may include a plurality of apertures, of which apertures 112, 114, 116, and 118 are exemplary. In the embodiment shown in FIG. 1, apertures 112 and 116 are positioned along centerline 106. Similarly, apertures 114 and 118 are positioned along centerline 108. Further, apertures 112-118 are positioned equidistant from center point 110. In at least one embodiment, as shown in FIG. 3, each aperture (e.g. aperture 112), may include a threaded bore 300 for receiving a bolt or screw mechanism (not shown).

Still referring to FIG. 1, focus device 100 includes a movable housing 120. As shown, housing 120 is an integral part of frame 102. Housing 120 further includes a center section 122, and a plurality of tabs, e.g. tabs 124, 126, 128 and 130. The tabs 124-130 are positioned an equal distance from the center point 110. Further, each tab 124-130 is oriented at an absolute acute angle “θ” relative to centerline 106. In this configuration, tabs 124-130 are symmetrical about center point 110, symmetrical about centerline 106, and symmetrical about centerline 108.

As shown, each tab 124-130 is formed as a continuous piece interconnecting housing 120 to the remainder of frame 102. Each tab 124-130, by virtue of its slotted design, permits movement of housing 120 relative to the remainder of frame 102.

In at least one embodiment, housing 120 may also include a plurality of mounting bolts, of which bolt 132 is exemplary. Cross-referencing for a moment FIGS. 1 and 3, bolt 132 engages aperture 302 (FIG. 3). When fully engaged, bolt 132 contacts outer surface 134 of frame 102. Similarly, a mounting bolt 304 is positioned opposite bolt 132 to engage an aperture 306. When fully engaged, bolt 304 contacts inner surface 136 of frame 102.

Focus device 100 includes a position sensor 138 mounted on housing 120. The position sensor 138 measures the axial movement of housing 120 out of plane 104, along an axis, e.g. axis 308 (FIG. 3). The position sensor 138 is of a type well known in the art, and may be a Hall sensor. The Hall sensor can be used to measure movement and relative position by generating an output voltage proportional to a magnetic flux perpendicular to the surface of a sensor chip. In at least one embodiment, the output signal of position sensor 138 is proportional to the “out of plane” axial movement. In yet another embodiment, the output signal is non-linear.

The focus device 100 also includes an image sensor 140 mounted substantially in the center of center section 122. In one embodiment, image sensor 140 may be a charge-coupled device (“CCD”) of a type well known in the art. Alternatively, in yet another embodiment, image sensor 140 may be a complementary metal oxide semiconductor (“CMOS”) also of a type well known in the relevant art. The image sensor 140 is a critical element in the operation of the camera, and may be thought of as a replacement for the film found in a traditional film camera.

The image sensor 140 is mounted to orient a light receptive surface 142 toward incoming light from an image. In at least one embodiment, image sensor 140 is mounted on, or in close proximity to, outer surface 134. A plurality of electrical interconnects, such as electrical interconnects 144 and 146 (shown in phantom in FIG. 1) electrically interconnect image sensor 140 to housing 120.

A processor/controller 148 is positioned to receive image data from image sensor 140. Processor/controller 148 may be mounted as part of focus device 100. Alternatively, processor/controller 148 may be remotely located and interconnected to image sensor 140 via an electrical cable (not shown). In at least one embodiment, processor/controller 148 uses image data in at least one focusing algorithm to direct and control the axial movement of housing 120 and image sensor 140, thereby modifying the focus of an image received by the camera. A suitable processor/controller 148 may be comprised of analog circuitry, a digital processor, a CPU programmed with control logic, a device driver, and combinations thereof.

Focus device 100 also includes an actuator mechanism for inducing movement of housing 120, and hence image sensor 140, axially out of plane 104 along axis 308. Referring now to FIG. 2, focus device 100 includes an actuator mechanism 200 shown in phantom. In one embodiment, the actuator mechanism 200 is an electro-mechanical actuator of a type well known in the art, such as a voice coil actuator 202. In general, a voice coil actuator combines a permanent magnetic field and a coil winding to produce a mechanical force proportional to a current applied to the coil. Electro-mechanical actuators, to include voice coil actuators, typically provide a larger range of motion than many other actuation techniques.

In at least one embodiment, voice coil actuator 202 comprises a plurality of magnets, of which magnets 204, 206, 208 and 210 are exemplary. Further, a coil 212 is positioned to surround center section 122 of housing 120. As shown, coil 212 is positioned in close proximity to magnets 204-210, between the magnets 204-210 and center section 122. Cross-referencing FIGS. 2 and 3, it can be appreciated that activation of voice coil actuator 202 can induce movement of housing 120 and image sensor 140 toward, or away from, incoming light 310 via a generated force Fₐ.

Voice coil actuator 202 is one mechanism known in the art for inducing movement of housing 120 and image sensor 140. In yet another embodiment, as shown in FIG. 4, a piezo-electric or piezo-bimorph actuator 400 is used to induce the necessary focusing movement. The use of piezo-bimorph actuators as bending structures is well known in the relevant art. In contrast to the electro-mechanical actuator discussed above, piezo-bimorph actuators do not dissipate energy while stationary, however, their range of motion is limited. A typical range of motion for a piezo-bimorph actuator, of the type used in a digital camera, is less than 300 microns. As such, piezo-bimorph actuators are typically used in smaller camera designs.

The simplified piezo-bimorph actuator 400 of FIG. 4 represents a typical actuator known in the art. Piezo-bimorph actuator 400 includes a pair of lead (plumbum) zirconate titanate (“PZT”) ceramic plates 402, 404. The PZT-ceramic plates are electro-active ceramics, the deformation of which can be induced and controlled by exposing the plates 402, 404 to an electric field. Application of an electric field to plates 402, 404 induces a bending moment, as represented in FIG. 4. The bending moment, in turn, causes actuator 400 to contact housing 120.

As shown, a force Fₐ is generated which acts against housing 120. As with voice coil actuator 202, the force Fₐ induces movement of housing 120 along axis 308, thereby moving image sensor 140 toward incoming light 406. Reduction of the electrical field applied to plates 402, 404 will reduce the magnitude of force Fₐ applied against housing 120, thereby inducing a “rearward” movement of plates 402, 404, housing 120, and image sensor 140.

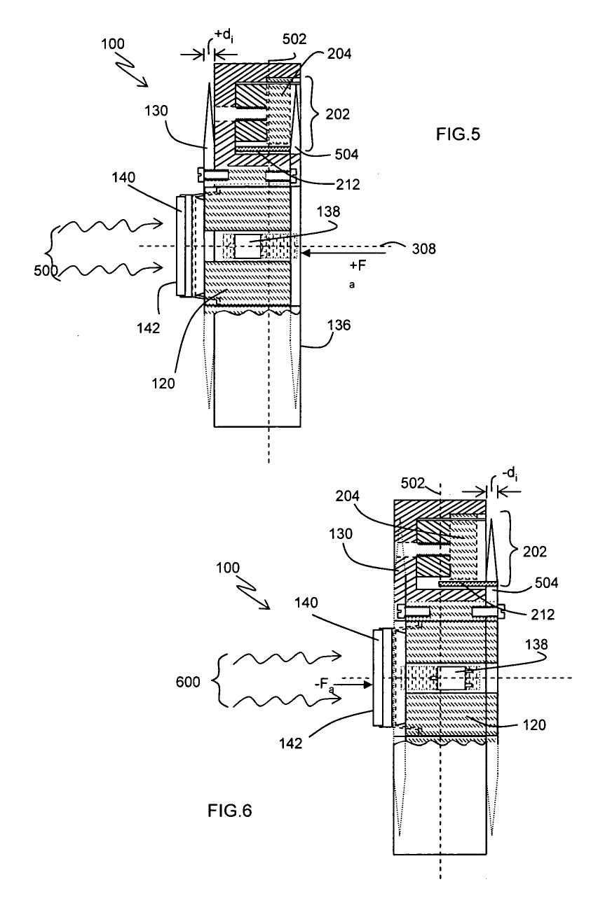

Considering now the functional operation of focus device 100 in greater detail, a force Fₐ (FIGS. 5 and 6) is generated by an actuator, e.g. voice coil actuator 202 or piezo-bimorph actuator 400. Force Fₐ induces movement of housing 120 and image sensor 140 along axis 308. As shown in FIG. 5, a force +Fₐ (which by convention may be designated as a force in the “forward” direction or toward incoming light 500) moves housing 120 an axial distance “+dᵢ” along axis 308.

As shown, tab 130 extends to allow for the movement of housing 120 and image sensor 140, as do the remaining tabs not shown, i.e. tabs 124, 126, 128. Further, it can be seen that position sensor 138 moves “forward” relative to a reference line 502 drawn through the center of focus device 100. The distance “+dᵢ” is measured by position sensor 138, and the measurement data is transmitted to processor/controller 148 for use in a focusing algorithm.

Of note, the activation of actuator mechanism 202 or 400 is controlled by processor/controller 148 as well. The processor/controller 148 continues to control the movement of housing 120 and image sensor 140 until the image received by light sensitive surface 142 is focused as determined by the processor/controller 148.

Also shown in FIG. 5 is a tab 504, positioned on inner surface 136. In at least one embodiment, focus device 100 includes a second set of tabs, of which tab 504 is exemplary. The second set of tabs mirror tabs 124-130, and allow for movement of housing 120 and image sensor 140 “rearward”, as discussed below.

In contrast to force +Fₐ, a force −Fₐ induces axial movement in a direction opposite the direction of movement induced by force +Fₐ. By convention, the direction may be referred to as “rearward”, which is to say away from incoming light 600 (FIG. 6). It can be seen in FIG. 6 that housing 120 and image sensor 140 move in a direction opposite that induced by force +Fₐ.

As shown, tab 504 extends to allow for movement along axis 308. It is understood that other tabs along surface 136 move in a manner similar to tab 504. Also, position sensor 138 moves “rearward” relative to reference line 502. Once again, the distance moved, i.e. “−dᵢ”, is measured by position sensor 138, and the measurement data is transmitted to processor/controller 148 for use in a focusing algorithm. In the manner described above, incoming light, e.g. light 500 or 600, and related images are focused by device 100, without the need to move a camera lens.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

What is claimed is:

1. A focus device for a camera comprising:
an image sensor;
a movable housing for containing the image sensor, the housing defining a plane;
an actuator mechanism for inducing a force substantially along an axis oriented perpendicular to the plane, to move the housing and image sensor axially and out of the plane;
a position sensor for generating an output signal proportional to an axial distance moved by the housing and image sensor; and
a controller for controlling the actuator mechanism, and for receiving the output signal from the position sensor, wherein the output signal is used by the controller as input to at least one focusing algorithm in the camera.

2. The focus device of claim 1, wherein the camera includes a digital camera.

3. The focus device of claim 1, wherein the image sensor includes a charge-coupled device.

4. The focus device of claim 1, wherein the image sensor includes a complementary metal oxide semiconductor.

5. The focus device of claim 1, wherein the actuator mechanism includes a voice coil actuator.

6. The focus device of claim 1, wherein the actuator mechanism includes a piezo-bimorph actuator.

7. The focus device of claim 1, wherein the position sensor includes at least one optical sensor, a capacitive sensor, Hall sensor, or combinations thereof.

8. A method for focusing a camera comprising:
controlling an actuator mechanism to move a housing containing an image sensor along an axis substantially perpendicular to a plane defined by the housing;
transmitting an output signal from a position sensor to a controller, wherein the output signal is indicative of an axial distance moved out of plane by the housing and image sensor; and
utilizing the output signal in at least one focusing algorithm to focus the camera.

9. The method of claim 8, wherein the camera includes a digital camera.

10. The method of claim 8, wherein the image sensor includes at least one charge-coupled device, complementary metal oxide semiconductor, or combinations thereof.

11. The method of claim 8, wherein the actuator mechanism includes at least one voice coil actuator, piezo-bimorph actuator, or combinations thereof.

12. The method of claim 8, wherein the position sensor includes at least one optical sensor, a capacitive sensor, Hall sensor, or combinations thereof.

13. The method of claim 8, wherein the output signal is proportional to the axial distance moved.

14. A focus device for a camera comprising:
an image sensor;
a movable housing for containing the image sensor, the housing defining a plane;
a means for moving the housing and image sensor out of plane along an axis substantially perpendicular to the plane;
a means for measuring an axial distance moved by the housing and image sensor; and
a means for controlling the moving means, and for receiving from the measuring means an output signal proportional to the axial distance moved, wherein the output signal is used by the camera as input to at least one focusing algorithm.

15. The focus device of claim 14, wherein the camera includes a digital camera.

16. The focus device of claim 14, wherein the image sensor includes at least one charge-coupled device, complementary metal oxide semiconductor, or combinations thereof.

17. The focus device of claim 14, wherein the moving means includes at least one voice coil actuator, piezo-bimorph actuator, or combinations thereof.

18. The focus device of claim 14, wherein the measuring means includes at least one optical sensor, a capacitive sensor, Hall sensor, or combinations thereof.

19. A camera comprising:
an image sensor for sensing incident light;
a movable housing for containing the image sensor, the housing defining a plane;
an actuator mechanism for inducing a force substantially along and an axis oriented perpendicular to the plane, to move the housing and image sensor axially out of plane;
a position sensor for generating an output signal proportional to an axial distance moved by the housing and image sensor;
at least one focusing algorithm; and
a controller for controlling the actuator mechanism, for receiving the output signal from the position sensor, and for inputting the output signal into the focusing algorithm to modify a focus of the camera.

20. The camera of claim 19, wherein the image sensor includes at least one charge-coupled device, complementary metal oxide semiconductor, or combinations thereof.

21. The camera of claim 19, wherein actuator mechanism includes at least one voice coil actuator, piezo-bimorph actuator, or combinations thereof.

22. The camera of claim 19, wherein the position sensor includes at least one optical sensor, a capacitive sensor, Hall sensor, or combinations thereof.
